(19) United States
(12) Patent Application Publication
(10) Pub. No.: US 2009/0050529 A1
(43) Pub. Date: Feb. 26, 2009

(54) FCC CO Oxidation Promoters

(75) Inventors: Darrell Ray Rainer, Houston, TX (US); Jorge Alberto Gonzalez, Houston, TX (US)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., Amersfoort (NL)

(21) Appl. No.: 12/135,399

(22) Filed: Jun. 9, 2008

Related U.S. Application Data
(60) Provisional application No. 60/942,784, filed on Jun. 8, 2007.

(51) Int. Cl. C10G 11/04; B01J 21/16

(52) U.S. Cl. 208/121; 502/84; 502/73; 502/74

(57) ABSTRACT

Compositions suitable for use in FCC processes are provided that are capable of providing improved CO oxidation promotion activity along with NOₓ emission control. Generally, compositions are provided for promoting CO oxidation in FCC processes, wherein the compositions contain (i) a basic material support, (ii) at least one oxide of a lanthanide series element, (iii), optionally, at least one oxide of a transition metal selected from Groups Ib and IIb of the Periodic Table and (iv) at least one precious metal. The basic material support is preferably a hydrotalcite-like compound.

A major industrial problem involves the development of efficient methods for reducing the concentration of air pollutants, such as carbon monoxide, sulfur oxides and nitrogen oxides in waste gas streams which result from the processing and combustion of sulfur, carbon and nitrogen containing fuels. The discharge of these waste gas streams into the atmosphere is environmentally undesirable at the sulfur oxide, carbon monoxide and nitrogen oxide concentrations that are frequently encountered in conventional operations. The regeneration of cracking catalyst, which has been deactivated by coke deposits in the catalytic cracking of sulfur and nitrogen containing hydrocarbon feedstocks, is a typical example of a process, which can result in a waste gas stream containing relatively high levels of carbon monoxide, sulfur and nitrogen oxides.

Catalytic cracking of heavy petroleum fractions is one of the major refining operations employed in the conversion of crude petroleum oils to useful products such as the fuels utilized by internal combustion engines. In fluidized catalytic cracking (FCC) processes, high molecular weight hydrocarbon liquids and vapors are contacted with hot, finely-divided, solid catalyst particles, either in a fluidized bed reactor or in an elongated transfer line reactor, and maintained at an elevated temperature in a fluidized or dispersed state for a period of time sufficient to effect the desired degree of cracking to lower molecular weight hydrocarbons of the kind typically present in motor gasoline and distillate fuels.

In the catalytic cracking of hydrocarbons, some nonvolatile carbonaceous material or coke is deposited on the catalyst particles. Coke comprises highly condensed aromatic hydrocarbons and generally contains from about 4 to about 10 weight percent hydrogen. When the hydrocarbon feedstock contains organic sulfur and nitrogen compounds, the coke also contains sulfur and nitrogen. As coke accumulates on the cracking catalyst, the activity of the catalyst for cracking and the selectivity of the catalyst for producing gasoline blending stocks diminishes. Catalyst which has become substantially deactivated through the deposit of coke is continuously withdrawn from the reaction zone. This deactivated catalyst is conveyed to a stripping zone where volatile deposits are removed with an inert gas at elevated temperatures. The catalyst particles are then reactivated to essentially their original capabilities by substantial removal of the coke deposits in a suitable regeneration process. Regenerated catalyst is then continuously returned to the reaction zone to repeat the cycle.

Catalyst regeneration is accomplished by burning the coke deposits from the catalyst surfaces with an oxygen containing gas such as air. The combustion of these coke deposits can be regarded, in a simplified manner, as the oxidation of carbon and the products are carbon monoxide and carbon dioxide.

High residual concentrations of carbon monoxide in flue gases from regenerators have been a problem since the inception of catalytic cracking processes. The evolution of FCC has resulted in the use of increasingly high temperatures in FCC regenerators in order to achieve the required low carbon levels in the regenerated catalysts. Typically, present day regenerators now operate at temperatures in the range of about 1100° F. to about 1400° F. when no promoter is used and result in flue gases having a CO₂/CO ratio in the range of 36 or higher, in a full burn unit to 0.5. The oxidation of carbon monoxide is highly exothermic and can result in so-called “carbon monoxide afterburning” which can take place in the dilute catalyst phase, in the cyclones or in the flue gas lines. Afterburning has caused significant damage to plant equipment. On the other hand, unburned carbon monoxide in atmosphere-vented flue gases represents a loss of fuel value and is ecologically undesirable.

Restrictions on the amount of carbon monoxide, which can be exhausted into the atmosphere and the process advantages resulting from more complete oxidation of carbon monoxide, have stimulated several approaches to the provision of means for achieving complete combustion of carbon monoxide in the regenerator.

Among the procedures suggested for use in obtaining complete carbon monoxide combustion in an FCC regeneration have been: (1) increasing the amount of oxygen introduced into the regenerator relative to standard regeneration; and either (2) increasing the average operating temperature in the regenerator or (3) including various carbon monoxide oxidation promoters in the cracking catalyst to promote carbon monoxide burning. Various solutions have also been suggested for the problem of afterburning of carbon monoxide, such as addition of extraneous combustibles or use of water or heat-accepting solids to absorb the heat of combustion of carbon monoxide.

Specific examples of treatments applied to regeneration operated in the complete combustion mode include the addition of a CO combustion promoter metal to the catalyst or to the regenerator. For example, U.S. Pat. No. 2,647,860 proposed adding 0.1 to 1 weight percent chromic oxide to a cracking catalyst to promote combustion of CO. U.S. Pat. No. 3,808,121 taught using relatively large-sized particles containing CO combustion-promoting metal into a regenerator. The small-sized catalyst is cycled between the cracking reactor and the catalyst regenerator while the combustion-promoting particles remain in the regenerator. Also, U.S. Pat. Nos. 4,072,600 and 4,093,535 teach the use of Pt, Pd, Ir, Rh, Os, Ru, and Re in cracking catalysts in concentrations of 0.01 to 50 ppm, based on total catalyst inventory to promote CO combustion in a complete burn unit.

The use of precious metals to catalyze oxidation of carbon monoxide in the regenerators of FCC units has gained broad commercial acceptance. Some of the history of this development is set forth in U.S. Pat. No. 4,171,286 and U.S. Pat. No. 4,222,856. In the earlier stages of the development, the precious metal was deposited on the particles of cracking catalyst. Present practice is generally to supply a promoter in the form of solid fluidizable particles containing a precious metal, such particles being physically separate from the particles of cracking catalyst. The precious metal or compound thereof, is supported on particles of suitable carrier material and the promoter particles are usually introduced into the regenerator separately from the particles of cracking catalyst. The particles of promoter are not removed from the system as fines and are cocirculated with cracking catalyst particles during the cracking/stripping/regeneration cycles. Judgment of the CO combustion efficiency of a promoter is done by the ability to control the difference in temperature, delta T, between the (hotter) dilute phase, cyclones or flue gas line, and the dense phase. Most FCC units now use a Pt CO combustion promoter. While the use of combustion promoters such as platinum reduce CO emissions, such reduction in CO emissions is usually accompanied by an increase in nitrogen oxides (NOx) in the regenerator flue gas.

Promoter products used on a commercial basis in FCC units include calcined spray dried porous microspheres of kaolin clay impregnated with a small amount (e.g., 100 to 1500 ppm) of platinum. Reference is made to U.S. Pat. No. 4,171,286 (supra). Most commercially used promoters are obtained by impregnating a source of platinum on microspheres of high purity porous alumina, typically gamma alumina. The selection of platinum as the precious metal in various commercial products appears to reflect a preference for this metal that is consistent with prior art disclosures that platinum is the most effective group VIII metal for carbon monoxide oxidation promotion in FCC regenerators. See, for example, FIG. 3 in U.S. Pat. No. 4,107,032 and the same figure in U.S. Pat. No. 4,350,614. The figure illustrates the effect of increasing the concentration of various species of precious metal promoters from 0.5 to 10 ppm on CO₂/CO ratio.

U.S. Pat. No. 4,608,357 teaches that palladium is unusually effective in promoting the oxidation of carbon monoxide to carbon dioxide under conditions such as those that prevail in the regenerators of FCC units when the palladium is supported on particles of a specific form of silica-alumina, namely leached mullite. The palladium may be the sole catalytically active metal component of the promoter or it may be mixed with other metals such as platinum.

U.S. Pat. Nos. 5,164,072 and 5,110,780, relate to an FCC CO promoter having Pt on La-stabilized alumina, preferably about 4-8 weight percent La₂O₃. It is disclosed that ceria “must be excluded.” At col. 3, it is disclosed that “In the presence of an adequate amount of La₂O₃, say about 6-8 percent, 2 percent Ce is useless. It is actually harmful if the La₂O₃ is less.” In an illustrative example '072 and '780 demonstrates an adverse effect of 8% Ce on CO promotion of platinum supported on a gamma alumina and a positive effect of La.

When sulfur and nitrogen containing feedstocks are utilized in catalytic cracking process, the coke deposited on the catalyst contains sulfur and nitrogen. During regeneration of coked deactivated catalyst, the coke is burned from the catalyst surface that then results in the conversion of a portion of the sulfur and nitrogen to sulfur oxides and nitrogen oxides, respectively.

Unfortunately, the more active combustion promoters such as platinum and palladium also serve to promote the formation of nitrogen oxides in the regeneration zone. It has been reported that the use of prior art CO promoters can cause a dramatic increase (e.g. >300%) in NOₓ. It is difficult in a catalyst regenerator to completely burn coke and CO without increasing the NOₓ content of the regenerator flue gas. Since the discharge of nitrogen oxides into the atmosphere is environmentally undesirable, the use of these promoters has the effect of substituting one undesirable emission for another. Many jurisdictions restrict the amount of NOₓ that can be in a flue gas stream discharged to the atmosphere. In response to environmental concerns, much effort has been spent on finding ways to reduce NOₓ emissions.

Various approaches have been used to either reduce the formation of NOₓ or treat them after they are formed. Most typically, additives have been used either as an integral part of the FCC catalyst particles or as separate particles in admixture with the FCC catalyst.

Various additives have been developed that will carry out CO promotion while controlling NOₓ emissions.

U.S. Pat. Nos. 4,350,614, 4,072,600 and 4,088,568 mention rare earth addition to Pt based CO promoters. An example is 4% RO that shows some advantage. There is no teaching of any effect of REO on decreasing NOₓ emissions from the FCCU.

U.S. Pat. No. 4,199,435 teaches a combustion promoter selected from the Pt, Pd, Ir, Os, Ru, Rh, Re and copper on an inorganic support.

U.S. Pat. No. 4,290,878 teaches a Pt—Ir and Pt—Rh bimetallic promoter that reduces NOₓ compared to conventional Pt promoter.

U.S. Pat. No. 4,300,997 patent teaches the use of a Pd—Ru promoter for oxidation of CO that does not cause excessive NOₓ formation.

U.S. Pat. No. 4,544,645 describes a bimetallic of Pd with every other Group VIII metal but Ru.

U.S. Pat. Nos. 6,165,933 and 6,358,881 to W. R. Grace describe compositions comprising a component containing (i) an acidic oxide support, (ii) an alkali metal and/or alkaline earth metal or mixtures thereof, (iii) a transition metal oxide having oxygen storage capability, and (iv) palladium; to promote CO combustion in FCC processes while minimizing the formation of NOₓ.

U.S. Pat. No. 6,117,813 teaches a CO promoter consisting of a Group VIII transition metal oxide, Group IIIB transition metal oxide and Group IIA metal oxide.

There is still a need, however, for improved CO oxidation promoters having NOₓ emission control in FCC processes.

The present invention provides novel compositions suitable for use in FCC processes that are capable of providing improved CO oxidation promotion activity along with NOₓ emission control.

In one aspect, the invention provides compositions for promoting CO oxidation in FCC processes, the compositions containing (i) basic material support, (ii) at least one oxide of a lanthanide series element, (iii), optionally, at least one oxide of a transition metal selected from Groups Ib and IIb of the Periodic Table and (iv) at least one precious metal. The basic material support is preferably a hydrotalcite-like compound.

In another aspect, the invention encompasses FCC processes using the CO oxidation promotion compositions of this invention either as an integral part of the FCC catalyst particles or as separate particles admixed with the FCC catalyst. The composition provides lower NOₓ emissions than prior art CO oxidation promoters.

In still another aspect of this invention, an additive for CO oxidation is provided by incorporating into a single particle, a platinum group metal for CO oxidation promotion and metal components for NOₓ decomposition, and in which the platinum group metal and other metals are distributed in separate areas of the particle to achieve improvements in NOₓ reduction.

These and other aspects of the invention are described in further detail below.

### BRIEF DESCRIPTION OF THE DRAWINGS

FIG. 1 is a graphic description of an additive of this invention illustrating the distribution of CO oxidation promoter and NOx decomposition components.

### DETAILED DESCRIPTION OF THE INVENTION

In one aspect, the invention encompasses the discovery that certain classes of compositions are very effective for both the oxidation of CO and reduction of NOₓ gas emissions in FCC processes. The CO oxidation compositions of the inventions are characterized in that they comprise (i) a basic material support, (ii) at least one oxide of a lanthanide series element, (iii), optionally, at least one oxide of a transition metal selected from Groups Ib and IIb of the Periodic Table and mixtures thereof and (iv) at least one precious metal.

Basic materials (both Lewis bases and Bronstedt bases) suitable for use as catalytic compositions in the present invention include, solid materials having vacancies, transition metals, and phosphates.

The basic material may be supported on a suitable carrier. For this purpose the basic material may be deposited on the carrier by any suitable method known in the art.

The carrier material may be acidic in nature. In many cases the basic material will cover the acidic sites of the carrier, resulting in a catalyst having the required basic character. Suitable carrier materials include the refractory oxides, in particular alumina, silica, silica-alumina, titania, zirconia, and mixtures thereof.

Suitable basic materials for use in the catalytic compositions of the present invention include compounds of alkali metals, compounds of alkaline earth metals, compounds of trivalent metals, compounds of transition metals, compounds of the Lanthanides, and mixtures thereof.

Suitable compounds include the oxides, the hydroxides and the phosphates of these elements.

A class of materials preferred as basic materials in the catalytic compositions of the present invention are mixed metal oxides, mixed metal hydroxides, and mixed metal phosphates. Cationic and anionic layered materials are suitable as precursors to mixed metal oxides.

Another group of preferred basic materials for the present invention are compounds of transition metals, in particular the oxides, hydroxides and phosphates. Preferred are compounds of transition metals that do not have a strong dehydrogenation activity. Examples of suitable materials include ZrO₂, Y₂O₃, and Nb₂O₅.

A preferred class of materials for use as basic catalytic compositions in the present invention are anionic clays, in particular hydrotalcite-like materials.

In hydrotalcite-like anionic clays, the brucite-like main layers are built up of octahedra alternating with interlayers in which water molecules and anions, more particularly carbonate ions, are distributed.

The interlayers may contain anions such as NO₃⁻, OH⁻, Cl⁻, Br⁻, I⁻, SO₄²⁻, SiO₃²⁻, CrO₄²⁻, BO₃²⁻, MnO₄⁻, HGaO₃²⁻, HVO₄²⁻, ClO₄⁻, BO₃²⁻, pillaring anions such as V₁₀O₂₈⁶⁻, monocarboxylates such as acetate, dicarboxylates such as oxalate, alkylsulfonates such as laurylsulfonate.

“True” hydrotalcite, that is hydrotalcites having magnesium as the divalent metal and alumina as the trivalent metal, is preferred for use in the present invention.

The catalytic selectivity of a hydrotalcite-like material (including hydrotalcite itself) may be improved by subjecting the hydrotalcite to heat deactivation. A suitable method for heat deactivating a hydrotalcite material comprises treating the material in air or steam for several hours, for example five to 20 hours, at a temperature of from 300 to 900° C. Heating causes the layered structure to collapse and amorphous material to be formed. Upon continued heating, a doped periclase structure is formed, in which some of the Mg²⁺ sites are filled with Al³⁺. In other words, vacancies are formed, which have been found to improve the selectivity of the catalytic material.

Extreme heat treatment will cause this material to segregate into a periclase and a spinel structure. Significant spinel formation has been observed after heating a hydrotalcite material for four hours at 900° C.

Another preferred class of basic materials is the aluminum phosphates.

Silica-magnesia is an example of a material having both basic and acidic sites.

Suitable predominately basic materials having acidic sites include silica sol, metal doped silica sol, and nano-scale composites of silica with other refractory oxides.

The amount of the lanthanide oxide(s) present in the additive composition of the present invention may be varied considerably relative to the amount of basic material support. Preferably, the additive composition contains at least about 0.5 part by weight of lanthanide oxide(s) per 100 parts by weight of the basic material support, more preferably from at least about 1 part by weight up to about 25 parts by weight of lanthanide oxide per 100 parts of the basic material support.

The Group Ib and/or IIb transition metals may be any metal or combination of metals selected from those groups of the Periodic Table. The amount of transition metal present is preferably at least about 100 parts by weight (measured as metal oxide) per million parts of the basic material support, more preferably from about 0.1 up to about 5 parts by weight per 100 parts of the basic material support.

The amount of precious metal can be varied considerably depending on the level of CO combustion promotion desired. Typical levels of precious metal will be in the range of 50 to 1500 ppm of total additive and/or catalyst. As used herein the precious metals include those selected from a group consisting of Ag, Cu, Pt, Pd, Ir, Os, Ru, Rh, Re and their precursors such as salts and amine complexes and mixtures thereof.

The additive composition may contain minor amounts of other materials, which preferably do not adversely affect the CO oxidation or NOₓ control function in a significant way. Reference herein to NOₓ control typically refers to the reduction of NOₓ emissions from the FCC process, although other types of control are contemplated by this invention including, for example, the maintenance of the NOₓ emission levels in the FCC unit where increased emissions of NOₓ are expected. The additive composition may consist essentially of items (i)-(iv) mentioned above, item (iii) being optional. Where the composition of the invention is used as an additive particle for an FCC process (as opposed to being integrated into the FCC catalyst particles themselves), the additive composition may be combined with fillers (e.g. clay, silica-alumina, silica and/or alumina particles) and/or binders (e.g. silica sol, alumina sol, silica alumina sol, etc.) to form particles suitable for use in an FCC process, preferably by spray drying before the calcination of step.

Where the additive composition is used as an additive particulate (as opposed to being integrated into the FCC catalyst particles themselves), the amount of additive component in the additive particles is preferably at least 50 wt %, more preferably at least 75 wt. %. Most preferably, the additive particles consist entirely of the additive component. The additive particles are preferably of a size suitable for circulation with the catalyst inventory in an FCC process. The additive particles preferably have an average particle size of about 20-200 μm. The additive particles preferably have attrition characteristics such that they can withstand the severe environment of an FCCU.

While the invention is not limited to any particular method of manufacture, the additive composition of the invention can be made by the following procedures: (a) co-impregnate the basic material support particles with a lanthanide oxide source and, optionally, at least one source of a Group lb/IIb element; (b) heat treat the impregnated support of step (a); (c) impregnate the formed material in step (b) with the desired level and choice of precious metal or precursor salt or complex, (d) optionally, re-heat treat the impregnated additive from step (c).

The sources of oxides are preferably slurries, sols and/or solutions of the metal oxides themselves or salts of the respective metals, which decompose to oxides on calcination, or combinations of oxides and salts. If desired, the individual constituents may be separately added to the support particles with a calcination step in between each addition. The heat treatment steps are preferably performed at about 450-750° C.

The additive composition may be used as a separate additive particle or as an integral part of an FCC catalyst particle. If used as an additive, the additive component may itself be formed into particles suitable for use in a FCC process. Alternatively, the additive component may be combined with binders, fillers, etc. by any conventional technique. See for example, the process described in U.S. Pat. No. 5,194,413, the disclosure of which is incorporated herein by reference.

Where the additive component of the invention is integrated into an FCC catalyst particle, preferably the component is first formed and then combined with the other constituents which make up the FCC catalyst particle. Incorporation of the additive composition directly into FCC catalyst particles may be accomplished by any known technique. Examples of suitable techniques for this purpose are disclosed in U.S. Pat. Nos. 3,957,689; 4,499,197; 4,542,188 and 4,458,623, the disclosures of which are incorporated herein by reference.

The compositions of this invention will not typically contain alkali and/or alkaline earth metals. The absence of the amount of alkali and/or alkaline earth metals shall mean less than about 1%, preferably, less than about 0.5% and, more preferably, less than about 0.1% alkali and alkaline earth metal present in the additive compositions of this invention. In another aspect of this invention, alkali and/or alkaline earth metals may be present in the additive composition of this invention so long as such metals are properly distributed in the additive particle, as will be further explained below.

The compositions of the invention may be used in any conventional FCC process. Typical FCC processes are conducted at reaction temperatures of 450 to 650° C. with catalyst regeneration temperatures of 600 to 850° C. The compositions of the invention may be used in FCC processing of any typical hydrocarbon feedstocks. Preferably, the compositions of the invention are used in FCC processes involving the cracking of hydrocarbon feedstocks which contain above average amounts of nitrogen, especially residual feedstocks or feedstocks having a nitrogen content of at least 0.1 wt. %. The amount of the additive component of the invention used may vary depending on the specific FCC process. Preferably, the amount of additive component used (in the circulating inventory) is about 0.05-15 wt. % based on the weight of the FCC catalyst in the circulating catalyst inventory. The presence of the compositions of the invention during the FCC process catalyst regeneration step effectively promotes the oxidation of CO while minimizing the ultimate level of NOₓ production as well.

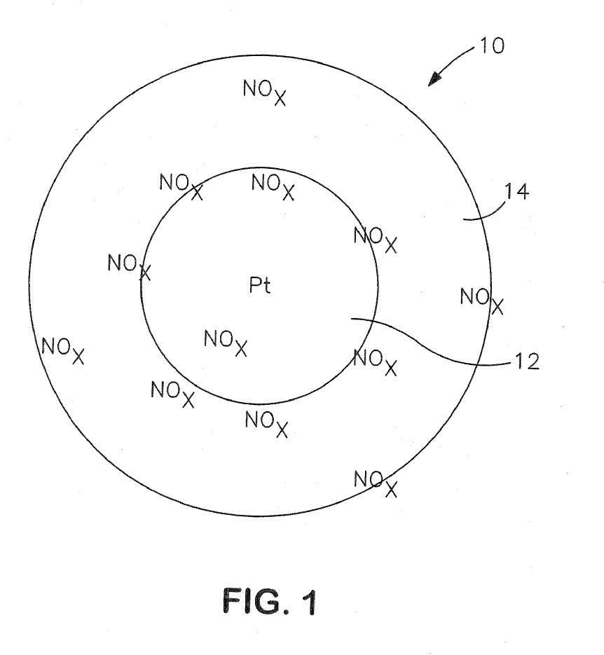

In another aspect of the present invention, a particulate additive for incorporation into an FCC process is described as having a specified distribution of precious metal so as to be effective in promoting the oxidation of carbon monoxide while minimizing NOₓ production. The additive of this aspect of the present invention is based on the concept of distributing the precious metal CO oxidation promoter within the center of the particulate additive and distributing throughout the particle any metal or metal oxides which have been found useful in the decomposition of NOₓ. A graphic depiction of the additive of this invention is shown in FIG. 1. As depicted in FIG. 1, the porous, particulate additive 10 will include a precious metal designated “Pt” such as previously described, which is primarily distributed in the center 12 of additive 10. What is theorized in accordance with this invention is that the precious metal such as Ag, Cu, Pt, Pd, Ir, Os, Ru, Rh, and/or Re distributed primarily in the central area 12 of the porous additive 10 will be able to promote the oxidation of CO to CO₂. However, as previously stated, not only do the above platinum group metals promote the oxidation of CO to CO₂, but a substantial amount of NOₓ is typically formed. In accordance with this invention, surrounding the core distribution 12 of the precious metal and even distributed through the core distribution 12 are metal or metal oxides designated “NOₓ” which are known to work in tandem with the precious metal to decompose NOₓ. Depicted in FIG. 1 is a shell 14 which can contain a large proportion of these other metal or metal oxides for decomposing NOₓ.

For example, shell distribution 14 and even core distribution 12 can include at least one lanthanide metal oxide as described above or other rare earth oxides. Also incorporated throughout particle 10, including the shell distribution 14, could be at least one oxide of transition metals selected from groups Ib and IIb of the Periodic Table, as also described previously. The NOₓ decomposition components may alternatively comprise alkaline metals or alkaline earth metals and transition metal oxides as described in the W. R. Grace patents mentioned previously. Aforementioned U.S. Pat. Nos. 6,165,933 and 6,358,881 are herein incorporated by reference in their entirety. Additionally, precious metals other than the precious metal contained in the core distribution 12 may be incorporated throughout particle 10. Thus, it is known in the prior art, including patents mentioned previously, that bimetallic precious metal CO oxidation promoters can also decompose NOₓ. Referring again to FIG. 1, it is believed that any NOₓ components formed by the precious metal in additive 10 will now be directed toward the outer surfaces of the particle, and would be trapped or otherwise decomposed to nitrogen such as in the shell distribution 14 containing the metal or metal oxide components, which are known to work in tandem with precious metals to decompose NOₓ. It is believed that the distribution as depicted in FIG. 1 minimizes the production of NOₓ during promotion of CO oxidation by precious metals. It is to be understood that a fine separation between precious metal in core distribution 12 and other metals or metal oxides in shell distribution 14 may not exist. It is likely and preferred that there be some overlap between the NOₓ decomposition components and core 12. In general, however, the primary distribution of precious metal will be in the far interior of the porous particulate substrate whereas the other metals or metal oxides will be primarily distributed near the outer surface of the particle.

To achieve the desired distribution of metal catalytic components as in the additive of this invention as depicted in FIG. 1, any known method can be used by this invention. In one such method, the porous substrate can first be impregnated with the precious metal. Upon impregnation and calcination to activate the metal, the support can then be coated with additional oxide which can then be impregnated with the NOₓ-decomposing metals. The NOₓ-decomposing metals may be alternatively mixed or impregnated into the coating composition. This process is described in U.S. Pat. No. 5,935,889, the entire content of which is herein incorporated by reference. In this method, a core distribution of the precious metal is subsequently coated with one or more incremental shell layers which can contain one or more of the NOₓ-decomposing metals that now surround the core precious metal distribution. The shell layers can be formed by a deposition process which uses a fluidized bed coating technique which involves repeatedly applying and drying small quantities of a slurry containing the shell material wherein the slurry is in the form of a colloidal dispersion, or sol or very fine particles.

It is also known to form an “egg yolk” catalyst distribution in which a catalyst component, in this case, precious metal, is concentrated at the particle center. Such process involves impregnating the particle with a precious metal solution or complex, alone or with a co-impregnant. It is known that convective flow of the liquids through the particle can be affected by specific drying models that can effectively distribute a metal into the desired interior of a prous particle. Subsequent impregnation can distribute one or more additional metals upon the outer surfaces of the porous support. The effect of different drying processes on catalyst distribution is described in “Predicting the Effect of Drying on Supported Coimpregnation Catalysts,” Lekhal et al., Ind. Eng. Chem. Res. 2001, 40, pgs. 3989-3999. This article is also incorporated in its entirety by reference herein.

Internal distribution of a platinum group metal is also known by impregnating a porous support with a platinum group salt and an acid that competes with the platinum salt for adsorption within the porous support. For example, a high surface area porous support can be contacted with a liquid solution of the active component. The active component enters the porous support via capillary action and diffusion and absorbs on the available surface sites. When alumina supports are impregnated solely with hexachloroplatinic acid, it has been found that the resulting catalyst profile is typically of the “eggshell” type, that being the platinum is located in a thin shell at the support surface. It has been known that the platinum distribution could be made more uniform or distributed in the center of a catalyst by co-impregnating the hexachloroplatinic acid with an acid such as HCl or citric acid wherein the platinum is now in a sub-surface band or within the core of the porous support. Other co-impregnants have been studied in order to change the distribution of the platinum component. Depending on the relative diffusion and adsorption strengths of the co-impregnants, the active component can be “pushed” into the interior of the particle. A review of this type of process is described in “Preparation of Pt/Gamma-Al₂O₃ Pellets with Internal Step-Distribution of Catalyst: Experiments and Theory,” Papageorgiou, et at., Journal of Catalysis 158, 1996, pgs 439-451, and “Catalysis: An Integrated Approach, Second, revised and enlarged edition,” Netherlands Institute for Catalysis Research, 1999, Chapter 10, the entire contents of which are herein incorporated by reference.

1. An particulate additive composition suitable for promoting the oxidation of CO during catalyst regeneration in a fluid catalytic cracking process, said composition comprising (i) a particulate basic material support, (ii) at least one precious metal for promoting CO oxidation, and (iii) metals or metal oxides capable of decomposing NOₓ, said at least one precious metal (ii) being primarily distributed in the central interior of said particulate additive and said metals or metal oxides (iii) primarily distributed throughout said particulate additive, including as a shell around said at least one precious metal.

2. The composition of claim 1 wherein said basic material support is a hydrotalcite-like compound.

3. The composition of claim 1 wherein said metals or metal oxides (iii) comprise at least one oxide of a lanthanide series element.

4. The composition of claim 3 wherein said metals or metal oxides (iii) further include a Group Ib and IIb transition metal.

5. The composition of claim 3 wherein said lanthanide oxide is present in amounts of from at least about 0.5 part by weight per 100 parts by weight of said basic material support.

6. The composition of claim 1 wherein the precious metal is at least one of the group consisting of Pt and Pd and the amount of precious metal in said composition is at least about 50 and less than about 1500 ppm.

7. The composition of claim 1 wherein said metals or metal oxides (iii) comprise alkali and/or alkaline earth metals.

8. A fluid cracking catalyst composition comprising (a) a cracking component suitable for catalyzing the cracking of hydrocarbons, and (b) a particulate additive composition comprising (i) a basic material support (ii) at least one precious metal for promoting CO oxidation, and (iii) metals or metal oxides capable of decomposing NOₓ, said at least one precious metal (ii) being primarily distributed in the central interior of said particulate additive and said metals or metal oxides (iii) primarily distributed throughout said particulate additive, including as a shell around said at least one precious metal, said additive composition being separate particles from the catalyst component and being present in the cracking catalyst in a sufficient CO emission reducing amount.

9. The cracking catalyst of claim 8 wherein the additive component (b) comprises about 0.05 to 15 wt % of the cracking catalyst composition.

10. A method of promoting CO oxidation during fluid catalytic cracking of a hydrocarbon feedstock into lower molecular weight components said method comprising contacting a hydrocarbon feedstock with a cracking catalyst suitable for catalyzing the cracking of hydrocarbons at elevated temperature whereby lower molecular weight hydrocarbon components are formed in the presence of a particulate CO oxidation promotion, wherein said particulate composition comprises (i) a basic material support (ii) at least one precious metal for promoting CO oxidation, and (iii) metals or metal oxides capable of decomposing NOx, said at least one precious metal (ii) being primarily distributed in the central interior of said particulate composition and said metals or metal oxides (iii) primarily distributed throughout said particulate composition, including as a shell around said at least one precious metal, said CO reduction composition being present in an amount sufficient to reduce said CO emissions.

11. The method of claim 10 wherein said cracking catalyst is fluidized during contact with a hydrocarbon feedstock.

12. The method of claim 11 further comprising recovering used cracking catalyst from said contacting step and treating said used catalyst under conditions to regenerate said catalyst.

13. The method of claim 12 wherein said hydrocarbon feedstock contains at least 0.1 wt % nitrogen.
